(19) United States
(12) Patent Application Publication
(10) Pub. No.: US 2005/0212879 A1
(43) Pub. Date: Sep. 29, 2005

(54) Replaceable electrostatically sprayable material reservoir for use with a electrostatic spraying device

(76) Inventors: DahShiarn Chiao, Albertson, NY (US); Chien-An Chang, Taipei (TW)

Correspondence Address: DahShiarn Chiao, 11 Wood Avenue, Albertson, NY, 11507, US

(21) Appl. No.: 10/817,402

(22) Filed: Mar. 29, 2004

(51) Int. Cl. B41J 2/085

(52) U.S. Cl. 347/86

(57) ABSTRACT

The present invention concerns a multiple replaceable reservoirs or cartridges system for use with electrostatic spraying device for use in spraying personal care and personal hygiene products. The electrostatic spraying device comprises at least one nozzle for electrostatically charged spray, an associated replaceable reservoir or cartridge for storing at least one electrostatically sprayable material, and a nozzle-ring configuration for generating the potential gradient electric field in the vicinity of the nozzles to such an extent that spraying is focused when the forward extremity of the nozzle-ring configuration is brought within a predetermine distance from an earthed target to be sprayed. The multiple replaceable reservoirs or cartridges system contains various electrostatically sprayable means for use by an associated electrostatic spraying device. The electrostatic spraying device is designed to be a portable, hand-held, self-contained, battery operated electrostatic multiple personal care and personal hygiene products releasing, with a multiple replaceable reservoirs or cartridges system. Additional embodiments of the present invention comprise nozzle-ring configuration and methods for effectively and efficiently releasing personal care and personal hygiene products stored in multiple replaceable reservoirs or cartridges system.

### FIELD OF THE INVENTION

The present invention concerns a multiple replaceable reservoirs or cartridges system for use in conjunction with an electrostatic spraying device having multiple electrostatic spraying capability, and in particular to a new multiple replaceable reservoirs or cartridges system for use with a hand-held or miniature electrostatic spraying device.

### BACKGROUND OF THE INVENTION

The present invention concerns a multiple replaceable reservoirs or cartridges system and electrostatic spraying device that are used to apply multiple hyperdermal cosmetics or medication in, e.g., personal care and personal hygiene products simultaneously. The multiple replaceable reservoirs or cartridges system can be manufactured in a fashion of either replaceable or integrated with electrostatic spraying device. When the multiple replaceable reservoirs or cartridges system and electrostatic spraying device are used in combination with various materials, several materials in electrostatically sprayable form may be released simultaneously for mixing and releasing at the multiple spraying nozzles units. Such multi-material electrostatic spraying is practical not only for cosmetic purposes, but also for therapeutic purposes.

The prior art concerning such reservoir and electrostatic spraying device, particularly with reference to those systems intended for use with current and contemplated multiple spraying systems, are best by a number of limitations. In particular, little thought has been given to how a multiple replaceable reservoirs or cartridges system and an electrostatic spraying device can be integrated into a hand-held or miniature device with multiple spraying capability.

### SUMMARY OF THE INVENTION

The limitations of the prior art are overcome in embodiments of the present invention. A first embodiment of the present invention comprises a multiple replaceable reservoirs or cartridges system which having at least one replaceable reservoir or cartridge. Each replaceable reservoir or cartridge further comprises an electrostatically sprayable material storage region, a replaceable or fixed spraying nozzles region, a material conducting tube region and a nozzle-ring configuration. The material storage region comprises a material storage structure and high voltage conducting structure. The replaceable spraying nozzles region comprises a material conducting channels and various arranged nozzles apparatus. The material conducting tube region comprises a passive feed arrangement or a user-induced electrostatically sprayable material pumping structure. The nozzle-ring configuration comprises a conducting or semi-insulating material which surrounds the nozzles and yields the necessary electric field around the nozzles during the initial application of voltage for spraying of the material. In general where the material to be sprayed is in the form of a liquid, the high voltage circuitry will have the effect of causing the propulsion of one or more filaments or ligaments of liquid from the nozzle, which ligament(s) break up into electrostatically charged droplets. Typically the material applied will comprise be of a cosmetic nature such as personal care products, eg deodorants, antiperspirants, anti-bacterials, perfumes, hair sprays, fresheners, moisturizers and conditioners etc.

A second embodiment of the present invention comprises a specific structure for a spraying nozzles region. The specific structure comprises a physical configuration in fixed relation to the body of the device or the body of the replaceable reservoir. In one variant of the second embodiment, the replaceable spraying nozzles region housing and the body of the device have terminals for conducting high voltage so the replaceable spraying nozzles region can be coupled to the source of high voltage through those terminals.

The replaceable reservoir or cartridge of the first embodiment comprises at least one material storage unit and at least one spraying nozzles unit. In one variant of the first embodiment, the reservoir comprises a plurality of separate electrostatically sprayable material storage region, a material pumping means and material conducting tube regions connecting the material storage regions to the spraying nozzles regions. The material pumping means comprises an actuating means for priming material through material conducting tube region during the electrostatic spraying operations to improve the flow of material from the material storage region to the spraying nozzles region. The actuating means comprises a cranking or an electromagnetic activation region having a material priming opening connecting with the spraying nozzles region for delivering material from the material storage region. The material conducting tube region and the material storage region provide sufficient air pressure to equalize with the air pressure over the opening of the actuating means after the pumping operations, and thereby prevents material from returning back to the material storage region. In another variant of the method of the first preferred embodiment, several materials in electrostatically sprayable form may be released simultaneously for mixing and releasing at the multiple spraying nozzles regions.

A third embodiment of the present invention comprises a specific structure for a nozzle-ring configuration. The specific structure comprises a physical configuration mounted in fixed relation to the body of the device or the body of the replaceable reservoir and the nozzle-ring configuration is in the form of an annular cable mounted on the body of device in substantially concentric relation with, and usually in fixed relation to, the spraying nozzles unit. The nozzle-ring configuration and the spraying nozzles unit may however be adjustable with respect to one another in the direction of spraying. Where the nozzles and/or the nozzle-ring configuration is adjustable, preferably the limits of adjustment are such that the nozzle-ring configuration, over substantially its full range of adjustment, has its forward extremity located forwardly of the nozzles. The arrangement is conveniently such that, in all positions of relative adjustment, spraying is suppressed and focused until the forward extremity of the nozzle-ring configuration is within a distance of 8cm (more preferably 2cm) from an earthed target. In addition, the nozzle-ring configuration surrounds the nozzles and yields the necessary electric field around the nozzles during the initial application of voltage for spraying of the material thus spraying is focused and also generating iontophoresis effect to enhance sprayed material transport through the skin until the forward extremity of the nozzle-ring configuration is within a distance of 2cm from a human skin target or an earthed target. In an alternative embodiment, the nozzle-ring configuration may be composed of a semi-insulating material which is coupled to a source of high voltage forming part of the device and has sufficient conductivity to permit a potential to be established at a location forwardly of the nozzles which is of the same polarity as that applied to the material emerging at the nozzle.

### BRIEF DESCRIPTION OF THE FIGURES

The above and other objects and advantages of this invention will be apparent upon consideration of the following detailed description, taken in conjunction with the accompanying drawings in which like characters refer to like elements throughout and in which:

FIG. 1 depicts front, rear and perspective views of a hand-held electrostatic spraying device and multiple replaceable reservoirs or cartridge made in accordance with a preferred embodiment of the present invention;

FIG. 2 depicts top and cross-sectional views of a multiple replaceable reservoir or cartridge made in accordance with a preferred embodiment of the present invention;

FIG. 2A depicts top and cross-sectional views of alternate multiple replaceable reservoir or cartridge made in accordance with a preferred embodiment of the present invention;

FIG. 2B depicts top and cross-sectional views of alternate multiple replaceable reservoir or cartridge made in accordance with a preferred embodiment of the present invention;

FIG. 3 depicts top and cross-sectional views of alternate replaceable reservoir or cartridge made in accordance with a preferred embodiment of the present invention;

FIG. 3A depicts top and cross-sectional views of alternate replaceable reservoir or cartridge made in accordance with a preferred embodiment of the present invention;

FIG. 4 depicts top and cross-sectional views of alternate replaceable reservoir or cartridge made in accordance with a preferred embodiment of the present invention;

FIG. 4A depicts top and cross-sectional views of alternate replaceable reservoir or cartridge made in accordance with a preferred embodiment of the present invention;

FIGS. 5 and 5A depict front, rear and cross-sectional view of a hand-held electrostatic spraying device having at least one replaceable reservoir or cartridge, at least one replaceable spraying nozzles region, a high voltage generator, a power source, control circuit, trigger and terminals connected to a high voltage generator made in accordance with a preferred embodiment of the present invention;

FIGS. 5B and 5C depict front, rear and cross-sectional view of a hand-held electrostatic spraying device having at least one replaceable reservoir or cartridge, at least one fixed spraying nozzles region, a high voltage generator, power source, control circuit, trigger and terminals connected to a high voltage generator made in accordance with a preferred embodiment of the present invention;

FIGS. 6 and 6A depict front, rear and cross-sectional view of a hand-held electrostatic spraying device having at least one replaceable reservoir or cartridge, at least one replaceable spraying nozzles region, a pumping means, a high voltage generator, power source, control circuit, trigger and terminals connected to a high voltage generator made in accordance with a preferred embodiment of the present invention;

FIGS. 6B and 6C depict front, rear and cross-sectional view of a hand-held electrostatic spraying device having at least one replaceable reservoir or cartridge, at least one fixed spraying nozzles region, a pumping means, a high voltage generator, power source, control circuit, trigger and terminals connected to a high voltage generator made in accordance with a preferred embodiment of the present invention.

### DETAILED DESCRIPTION OF THE PREFERRED EMBODIMENTS

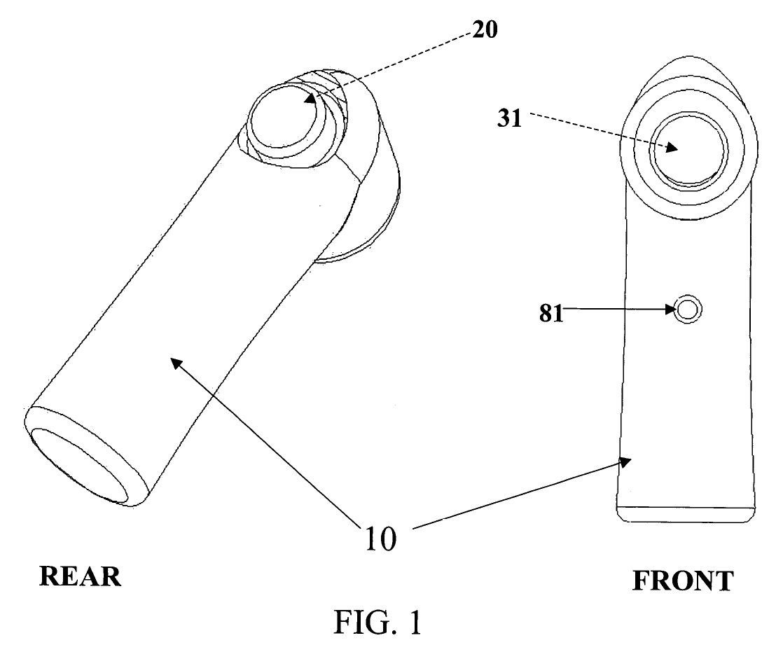

A hand-held electrostatic spraying device made in accordance with the first preferred embodiments of the present invention is depicted in perspective, front and rear views in FIG. 1. The hand-held electrostatic spraying device 10 integrated multiple replaceable reservoir or cartridge 20 is depicted attached to a hand-held electrostatic spraying device 10.

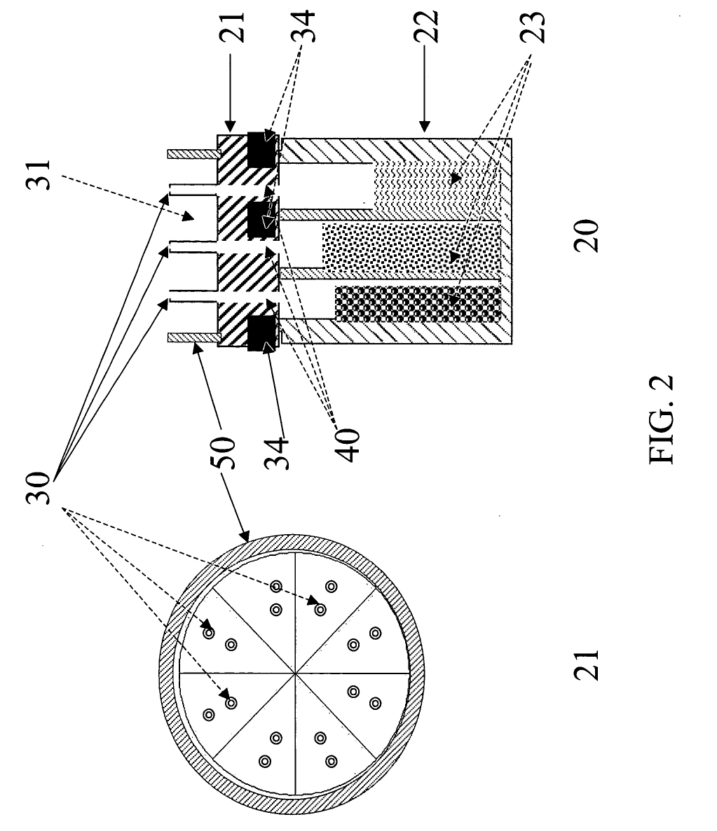

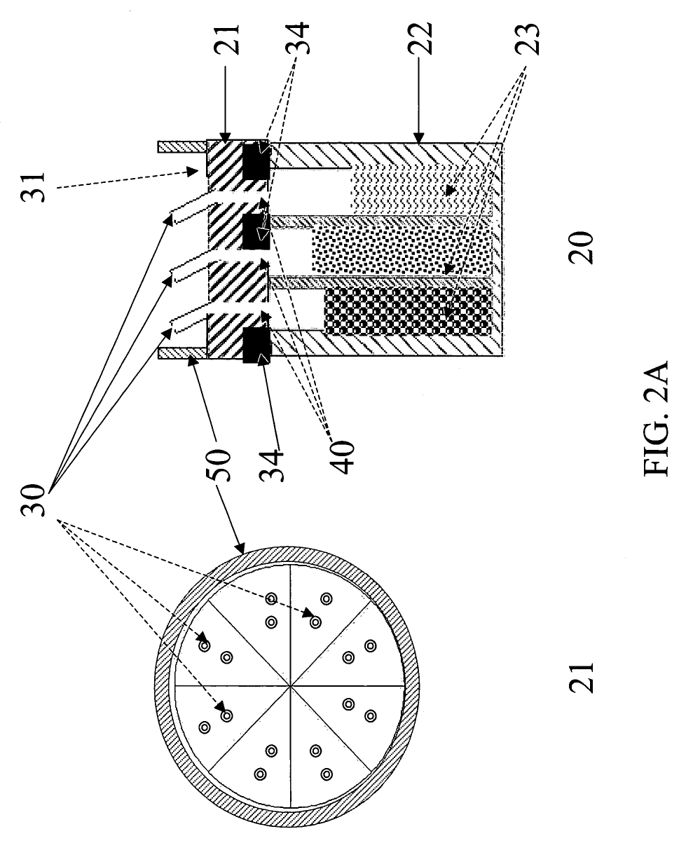

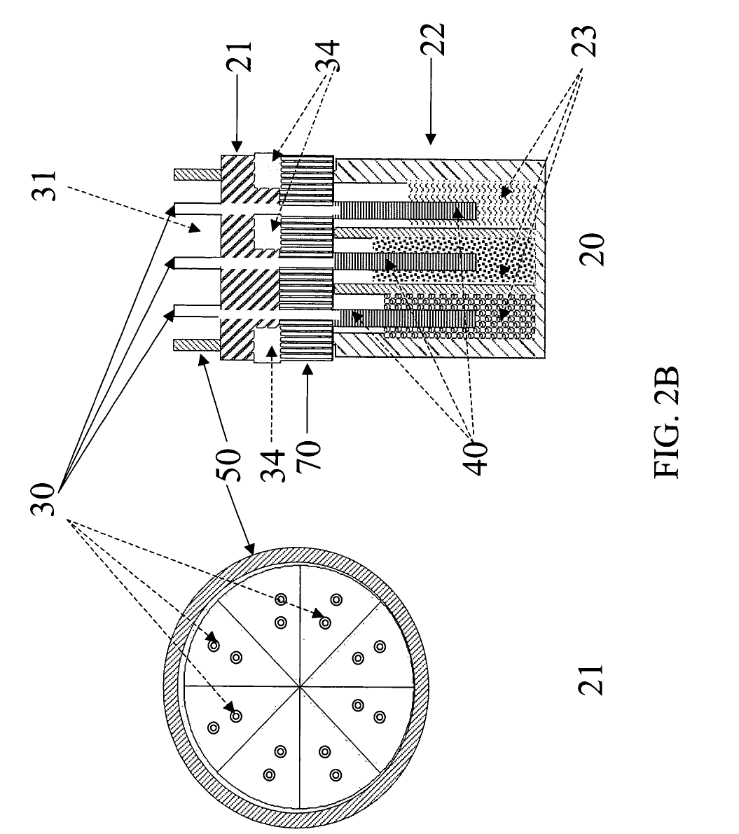

A multiple replaceable reservoir or cartridge made in accordance with the first preferred embodiments of the present invention is depicted in top and cross-sectional views in FIG. 2. The multiple replaceable reservoir or cartridge 20 shown in FIG. 2 comprises a plurality of separate electrostatically sprayable material storage region 22, each of which is contained in a three-dimensional sector of the replaceable reservoir or cartridge. The replaceable reservoir or cartridge 20 has a material conducting tube region 40 that is continuously in directly connect with the spraying nozzles region 31. Delivery of an electric charge through a selected terminal 34 to a designated spraying nozzles 30 sublimates the electrostatically sprayable material into many droplets which are focused when the forward extremity of the nozzle-ring configuration 50 is brought within a predetermine distance from an earthed target to be sprayed.

FIG. 2A depicts variants of the first preferred embodiment in which the nozzles 30 is mounted in fixed relation to the body of the multiple replaceable reservoir 20.

In one alternative embodiment shown in FIG. 2B, a multiple replaceable reservoir or cartridge 20 comprises a plurality of separate electrostatically sprayable material storage region 22, each of which is contained in a three-dimensional sector of the replaceable reservoir or cartridge. The replaceable reservoir or cartridge 20 has a material conducting tube region 40 and a pumping means 70 that is continuously in directly connect with the spraying nozzles region 31 in which pumping of the material is produced in response to operation of actuating means by the user. Delivery of an electric charge through a selected terminal 34 to a designated spraying nozzles 30 sublimates the electrostatically sprayable material into many droplets which are focused when the forward extremity of the nozzle-ring configuration 50 is brought within a predetermine distance from an earthed target to be sprayed.

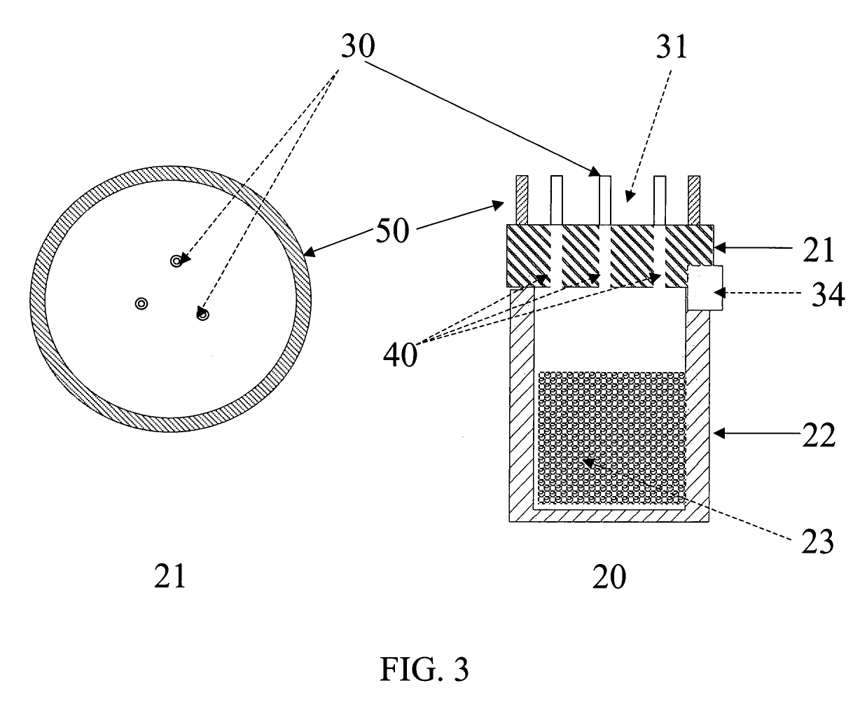

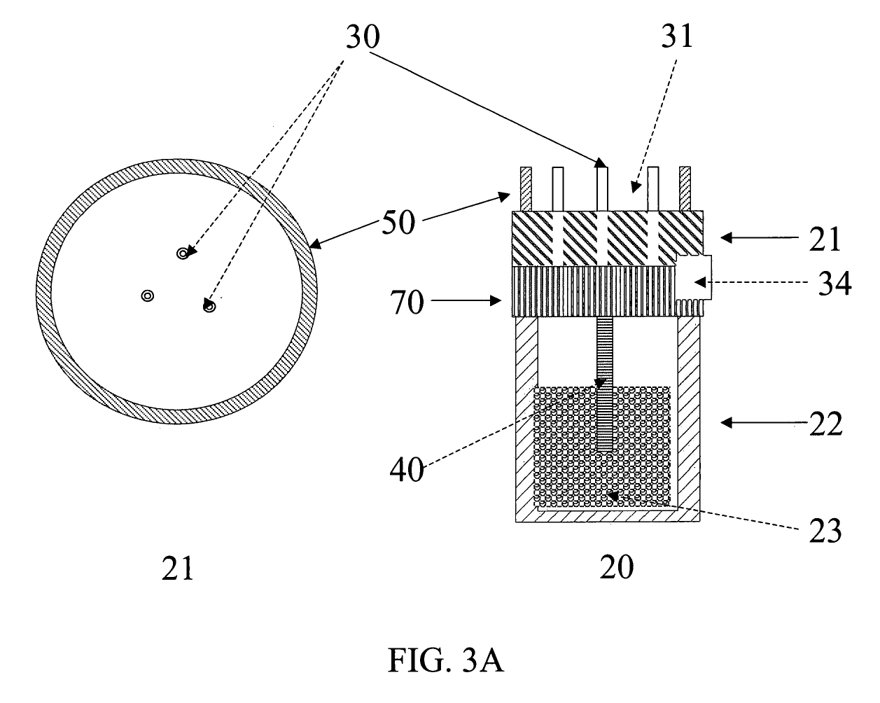

In another alternative embodiment shown in FIG. 3, a replaceable reservoir or cartridge 20 comprises an electrostatically sprayable material storage region 22, which is contained in a three-dimensional sector of the replaceable reservoir or cartridge. The replaceable reservoir or cartridge 20 has a material conducting tube region 40 that is continuously in directly connect with the spraying nozzles region 31. Delivery of an electric charge through the terminal 34 to spraying nozzles 30 sublimates the electrostatically sprayable material into many droplets which are focused when the forward extremity of the nozzle-ring configuration 50 is brought within a predetermine distance from an earthed target to be sprayed.

In another alternative embodiment shown in FIG. 3A, a replaceable reservoir or cartridge 20 comprises a electrostatically sprayable material storage region 22, which is contained in a three-dimensional sector of the replaceable reservoir or cartridge. The replaceable reservoir or cartridge 20 has a material conducting tube region 40 and a pumping means 70 that is continuously in directly connect with the spraying nozzles region 31 in which pumping of the material is produced in response to operation of actuating means by the user. Delivery of an electric charge through the terminal 34 to spraying nozzles 30 sublimates the electrostatically sprayable material into many droplets which are focused when the forward extremity of the nozzle-ring configuration 50 is brought within a predetermine distance from an earthed target to be sprayed.

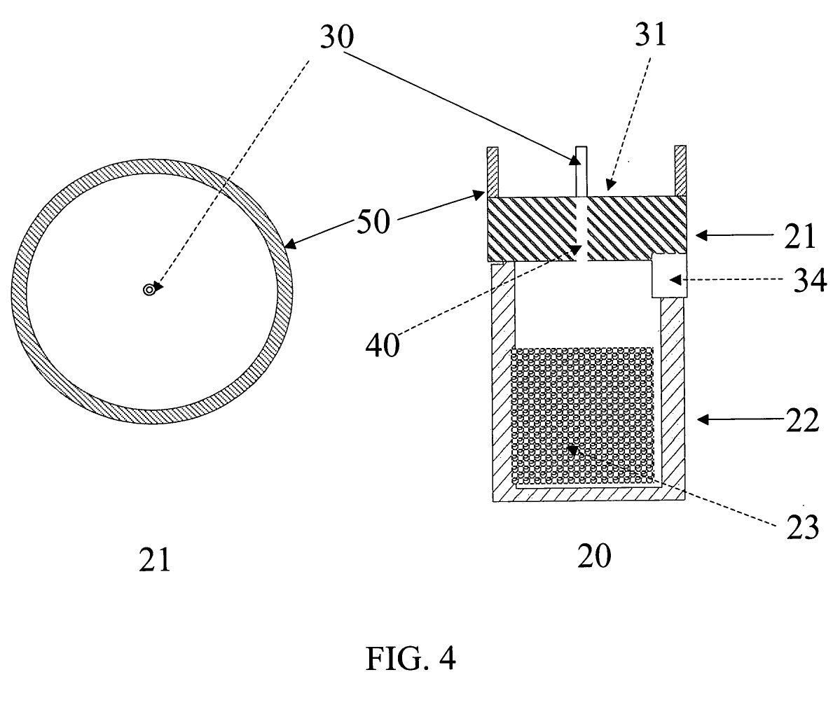

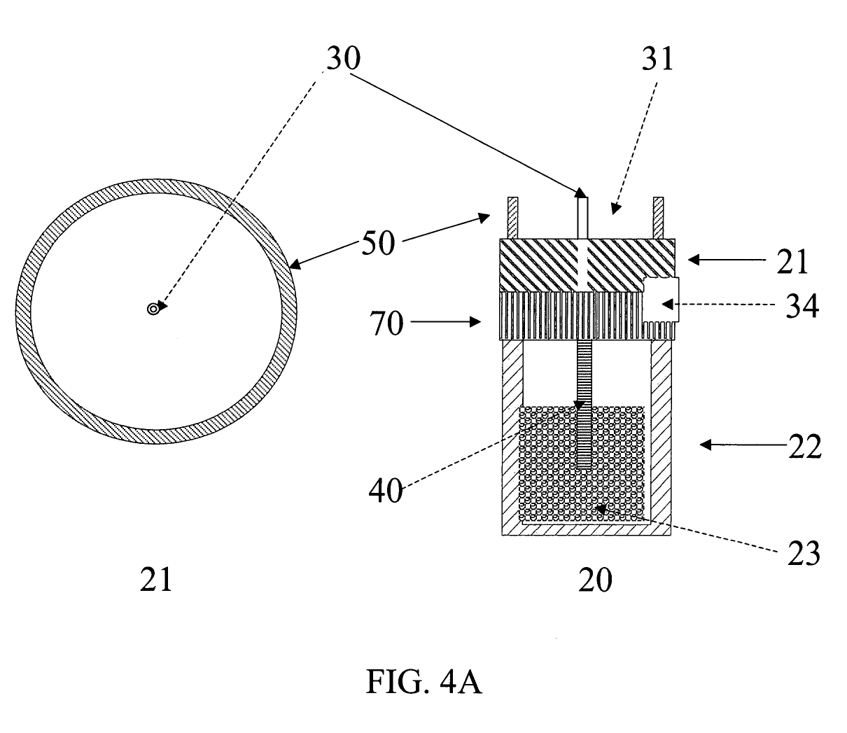

In yet other embodiment of the present invention, the replaceable reservoir 20 can also include just one nozzle 30, as showed in FIG. 4, one nozzle 30 and a pumping means 70, as showed in FIG. 4A

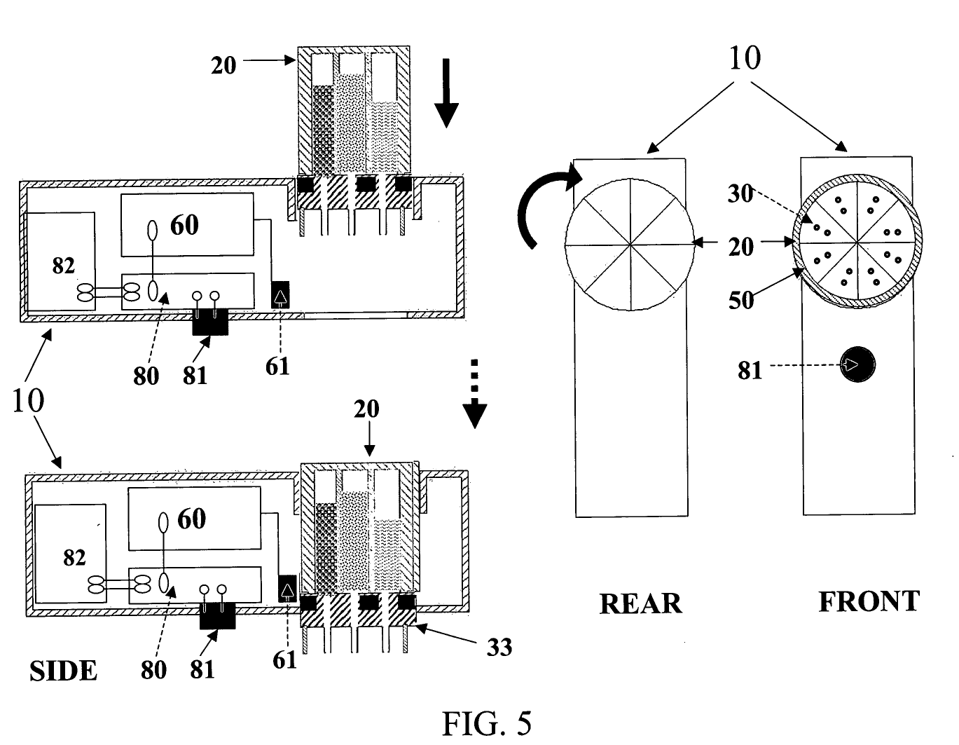

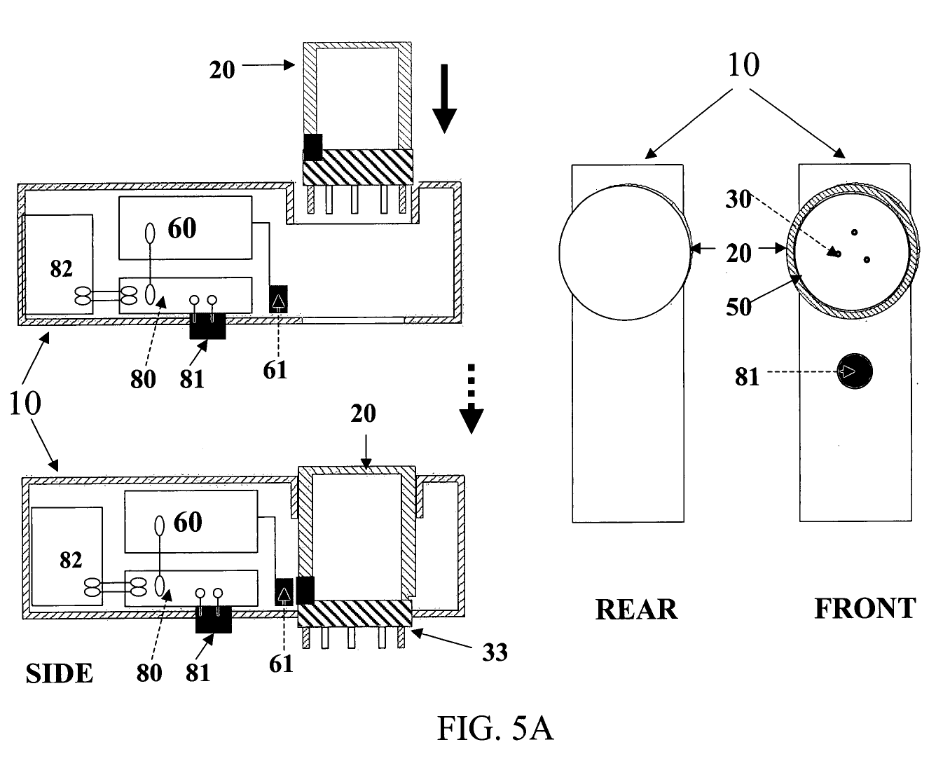

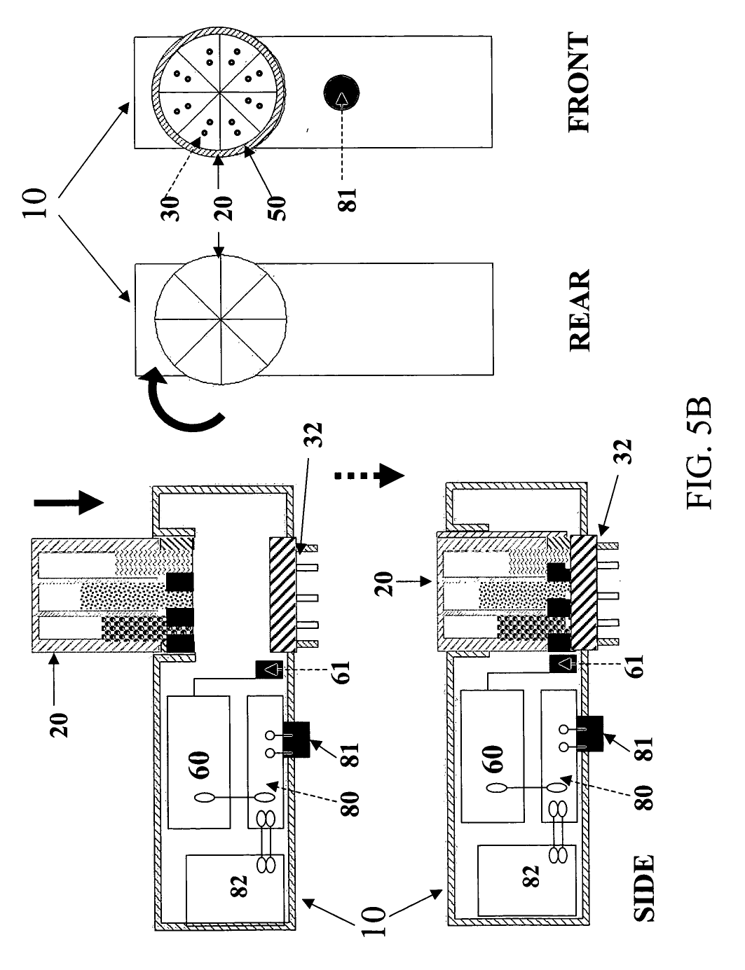

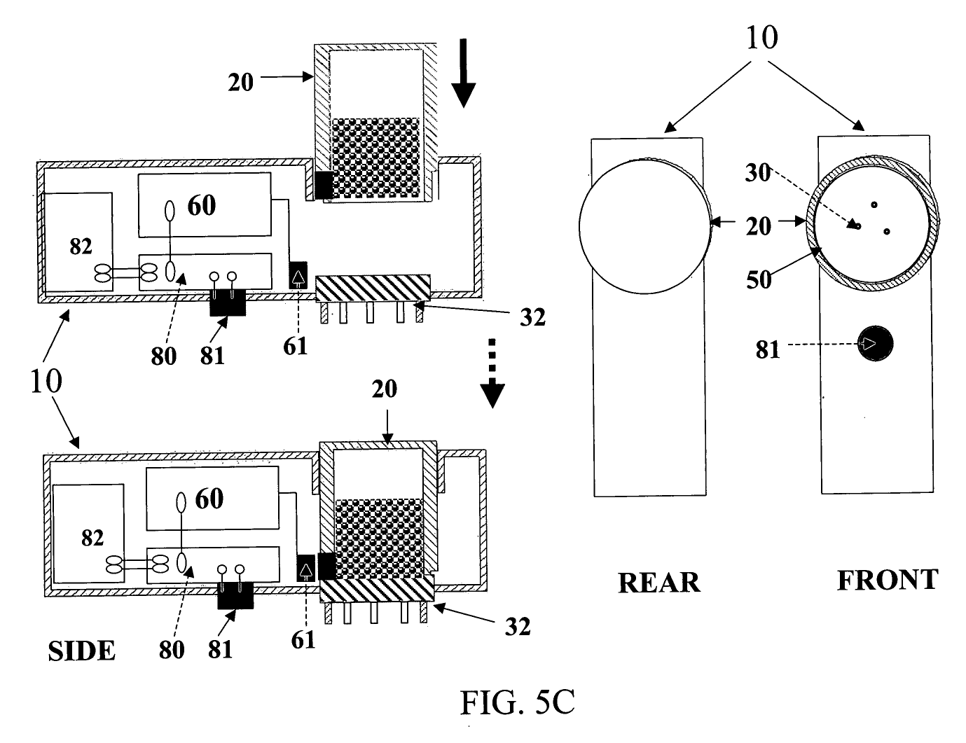

A complete hand-held electrostatic spraying device 10 having multiple replaceable reservoir or cartridge 20, at least one replaceable spraying nozzles region 33, a high voltage generator 60, a power source 82, control circuit 80, a trigger 81 and terminals 61 connected to the high voltage generator 60 made in accordance with the first preferred embodiment of the present invention is shown in FIG. 5. The multiple replaceable reservoir or cartridge 20 shown in FIG. 5 comprises a plurality of separate electrostatically sprayable material storage region 22, each of which is contained in a three-dimensional sector of the replaceable reservoir or cartridge. The hand-held electrostatic spraying device 10 has multiple terminals 61 that directly connect with a high voltage generator 60. By connecting the terminals 61 to a designated terminal 34 from a multiple replaceable reservoir or cartridge 20, delivery of an electric charge through selected terminals 61 and 34 sublimates the electrostatically sprayable material into many droplets which are focused when the forward extremity of the nozzle-ring configuration 50 is brought within a predetermine distance from an earthed target to be sprayed.

In one alternative embodiment shown in FIG. 5A, a hand-held electrostatic spraying device 10 having wiring 014 can be integrated with a replaceable reservoir or cartridge 20 having single electrostatically sprayable material storage region 22 to ionize single material into electrostatically charged droplets.

In another alternative embodiment shown in FIGS. 5B and 5C, a hand-held electrostatic spraying device 10 having a plurality of separate electrostatically sprayable material storage region 22 or having a single electrostatically sprayable material storage region 22 can be integrated with a fixed spraying nozzles region 32 to generate single or multiple materials into electrostatically charged droplets. Each material 23 from individual material storage region 22 can be applied an electric charge through a selected terminals 61 and 34 in a passive feed arrangement.

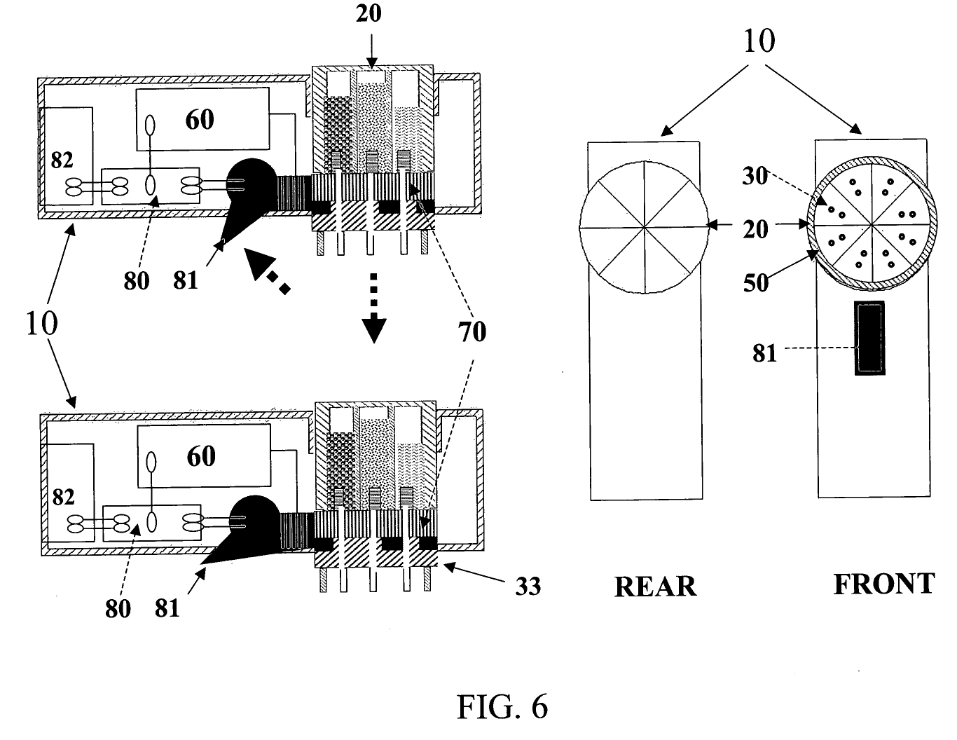

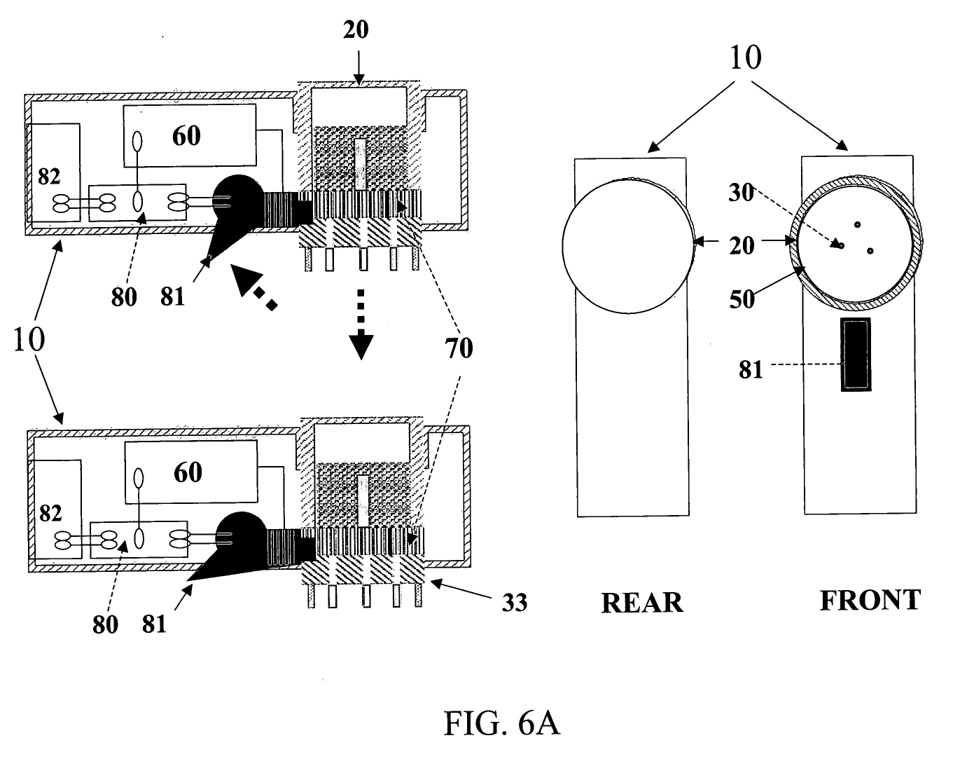

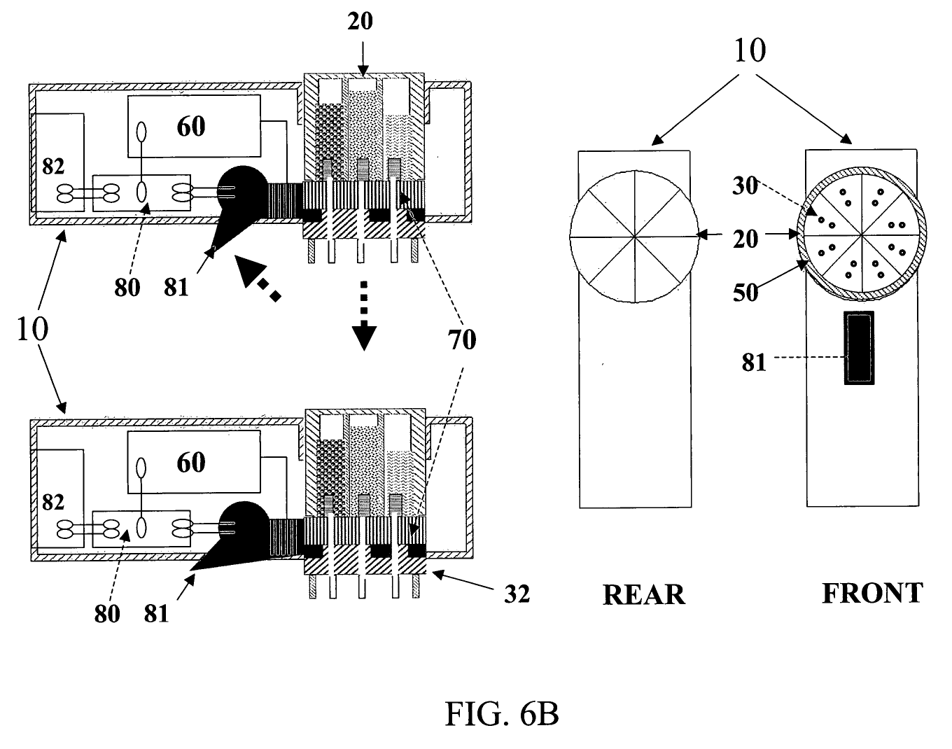

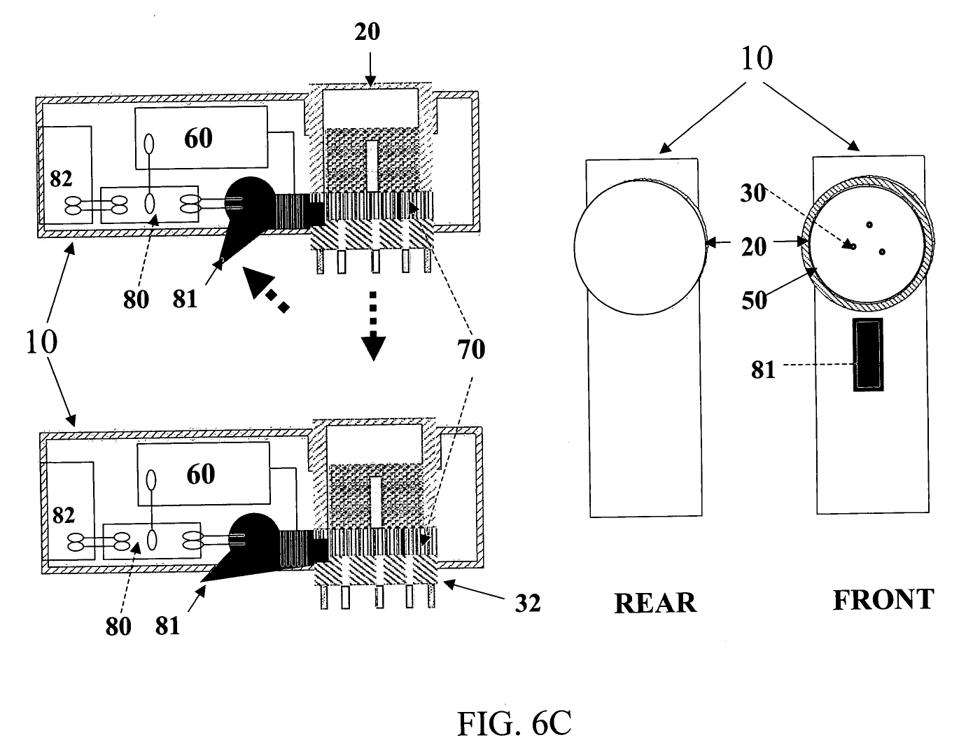

In a further alternative embodiment shown in FIGS. 6 and 6A, a hand-held electrostatic spraying device 10 having a plurality of replaceable reservoir or cartridge 20 or having a single replaceable reservoir or cartridge 20 can be applied through a pumping means 70 to supply material 23 from the material storage region 22 to the spraying nozzles region 31 for further electrostatic spraying at nozzles.

In yet other embodiment of the present invention shown in FIGS. 6B and 6C, a hand-held electrostatic spraying device 10 having a plurality of separate electrostatically sprayable material storage region 22 or having a single electrostatically sprayable material storage region 22 can be integrated with a fixed spraying nozzles region 32 to generate single or multiple materials into electrostatically charged droplets. Each material 23 from individual material storage region 22 can be supplied to the spraying nozzles region 31 through a pumping means 70 for further electrostatic spraying at nozzles.

1. A multiple replaceable reservoirs or cartridge for use with electrostatic spraying device of the type wherein at least one electrostatically sprayable material is contained in a reservoir housing, the electrostatic spraying device comprising high voltage circuitry arranged so that, in use, the material issuing from the spraying nozzles in a direction away from said spraying nozzles forms an electrostatically charged spray, said spray having a high voltage and a polarity and wherein an electric field forms in the vicinity of the nozzles during use, the multiple replaceable reservoirs or cartridges comprising:
at least one electrostatically sprayable material storage region;
at least one replaceable or fixed spraying nozzles region;
at least one material conducting tube region connecting the material storage region to the spraying nozzles region, wherein during electrostatic spraying operations material flows from the material storage region to the spraying nozzles region either in passive or user-induced arrangement; and
at least one nozzle-ring configuration for generating the electric field in the vicinity of the nozzles so that spraying from the nozzles is focused when the forward extremity of the nozzle-ring configuration is brought within a predetermine distance from an earthed target to be sprayed.

2. A method as claimed in claim 1 in which the nozzles is mounted in fixed relation to the body of the device and the nozzle-ring configuration is in the form of an annular cable mounted on the body of device in substantially concentric relation with, and usually in fixed relation to, the nozzles. The nozzle-ring configuration and the nozzles may however be adjustable with respect to one another in the direction of spraying.

3. A method as claimed in claim 1 in which the nozzles is mounted in fixed relation to the body of the multiple replaceable reservoirs and the nozzle-ring configuration is in the form of an annular cable mounted on the body of reservoir in substantially concentric relation with, and usually in fixed relation to, the nozzles. The nozzle-ring configuration and the nozzles may however be adjustable with respect to one another in the direction of spraying.

4. A device as claimed in claim 2 wherein the tip of the nozzle is mounted in fixed relation to the body of the device and mounted at an arranged angle, typically of about 45 degree, to the axis of the body of the device.

5. A device as claimed in claim 3 wherein the tip of the nozzle is mounted in fixed relation to the top of the multiple replaceable reservoirs and mounted at an arranged angle, typically of about 45 degree, to the axis of the top of the multiple replaceable reservoirs.

6. A device as claimed in claim 2 wherein the tip of the nozzle tube is mounted in fixed relation to the body of the device and mounted at an arranged angle, typically in the range of from 0 to 45 degree, to the axis of the body of the device.

7. A device as claimed in claim 3 wherein the tip of the nozzle is mounted in fixed relation to the top of the multiple replaceable reservoirs and mounted at an arranged angle, typically in the range of from 0 to 45 degree, to the axis of the top of the multiple replaceable reservoirs.

8. A device as claimed in claim 2 wherein the multiple spraying nozzles units are mounted in fixed relation to the body of the device and to the body of an individual reservoir, and several materials in electrostatically sprayable form may be released simultaneously for mixing and releasing at the multiple spraying nozzles units.

9. A device as claimed in claim 3 wherein the multiple spraying nozzles units are mounted in fixed relation to the top of each multiple replaceable reservoirs, and several materials in electrostatically sprayable form may be released simultaneously for mixing and releasing at the multiple spraying nozzles units.

10. An electrostatic spraying device comprising casing housing a high voltage generator, a dispensing nozzles from which an electrostatically sprayable material is sprayed in use wherein when sprayed said spray had a voltage and a polarity, reservoirs for containing materials to be sprayed in bulk wherein during use said reservoir contains bulk material to be sprayed, further comprises:
a pumping means for supplying said material through a passage leading to the dispensing nozzles, means coupling the high voltage output of the generator to the bulk material so that the voltage is conducted through the bulk material to the material present at the dispensing nozzles whereby the material issuing from the nozzles under the influence of an applied voltage forms an electrostatically charged spray wherein an electric field forms in the vicinity of the nozzles during use, characterized by the provision of a nozzle-ring configuration on which a voltage of the same polarity as that applied to the material to be sprayed is developed in use, the nozzle-ring configuration being located forwardly of the dispensing nozzles in the direction of spraying and arranged in such a way as to generate the electric field in the vicinity of the nozzles so that spraying from the nozzles is focused to prevent immediate loss of the charged aerosol and prevent spraying from the nozzles.

11. A device as claimed in claim 10 wherein the nozzle-ring configuration generates the electric field such that spraying from the nozzles is focused to prevent immediate loss of the charged aerosol and prevent spraying from the nozzles when the forward extremity of the nozzle-ring configuration is brought within a predetermine distance from an earthed target to be sprayed.

12. A device as claimed in claim 10 in which the pumping means comprises means for pneumatically pumping said the material from the reservoir to the nozzle.

13. A device as claimed in any one of claims 10 in which pumping of the material is produced in response to operation of actuating means by the user.

14. A device as claimed in claim 13 in which operation of the actuating means is accompanied by priming of the passage leading to the nozzle outlet with the material in preparation for pumping.

15. A device as claimed in claim 14 in which operation of the actuating means is also accompanied by operation of a high voltage generator associated with the means for applying high voltage to the material to be electrostatically sprayed whereby all of these operations together with pumping of the material are effected in response to a single operation of the actuating means by the user.

16. A device as claimed in claim 14 in which pumping of the material and/or application of the high voltage thereto are affected in response to a separate operation of the actuating means or operation of a different actuating means which effects pumping and/or electrostatically spraying.

17. An electrostatic spraying device comprising casing housing a high voltage generator, a special arranged dispensing nozzles from which an electrostatically sprayable material is sprayed in use wherein when sprayed said spray had a voltage and a polarity, multiple replaceable or fixed reservoirs for containing materials to be sprayed wherein during use said reservoirs contain materials to be sprayed, means coupling the high voltage output of the generator to the material so that the voltage is conducted through the materials to the materials present at the dispensing nozzles whereby the materials issuing from the nozzles under the influence of an applied voltage forms an electrostatically charged spray, further comprising a nozzle-ring configuration on which a high voltage of the same polarity as that applied to the materials to be sprayed is developed in use, the nozzle-ring configuration being located forwardly of the nozzles in the direction of spraying and arranged in such a way as to generate the electric field in the vicinity of the nozzles so that spraying from the nozzles is focused when the forward extremity of the nozzle-ring configuration is brought within a predetermine distance from an earthed target to be sprayed.

18. A method as claimed in claim 17 in which the nozzles is mounted in fixed relation to the body of the device and the nozzle-ring configuration is in the form of an annular cable mounted on the body of device in substantially concentric relation with, and usually in fixed relation to, the nozzles. The nozzle-ring configuration and the nozzles may however be adjustable with respect to one another in the direction of spraying.

19. A device as claimed in claim 17 in which the means for supplying said material to the nozzles is operable to feed the material passively.

20. A device as claimed in claim 17 in which the means for supplying said material to the nozzles is operable to feed the material by a user-induced operation.

21. A device as claimed in claim 17 wherein said device further generates iontophoresis effect to enhance sprayed material transport through the skin until the forward extremity of the nozzle-ring configuration is within a distance of 2 cm from a human skin target or an earthed target.

22. A device as claimed in claim 18 wherein said device further comprises a source of high voltage and wherein the nozzle-ring configuration is composed of a semi-insulating material which is coupled to the source of high voltage, said semi-insulating material having sufficient conductivity to permit a potential to be established at a location forwardly of said nozzles which is of the same polarity as that applied to the material emerging at the nozzles.
